(19) United States
(12) Patent Application Publication
(10) Pub. No.: US 2003/0082445 A1
(43) Pub. Date: May 1, 2003

(54) Battery pouch

(76) Inventors: W. Novis Smith, Philadelphia, PA (US); Joel McCloskey, Philadelphia, PA (US)

Correspondence Address: JOHN LEZDEY, 1409 A NORTH FT HARRISON, CLEARWATER, FL, 33755, US

(21) Appl. No.: 10/001,459

(22) Filed: Oct. 25, 2001

(51) Int. Cl. H01M 2/02; H01M 10/04

(52) U.S. Cl. 429/176; 429/185; 29/623.2

(57) ABSTRACT

A pouch is provided for an electrochemical cell which does not permit permeation of the solvent vapors of the electrolyte which consists of a film of a polar polymer layer sandwiched between two polyolefin layers. The pouch is a container for primary and secondary batteries and a liner for containers of electrolytes.

### FIELD OF THE INVENTION

The present invention relates to a battery pouch for lithium ion batteries and lithium polymer electrolyte batteries consisting of a plurality of cells which is resistant to the permeation of solvents and chemicals that may cause a loss of cell performance.

### BACKGROUND OF THE INVENTION

The increasing use of portable electronic devices has brought with it an increasing demand for batteries which provide more energy in smaller and lighter units. One approach to meeting these demanding requirements, for military, commercial and consumer uses, has been to incorporate more active materials, such as lithium or lithiated carbon, as the negative electrode. Lithium batteries, in general, provide higher energy density, higher specific energy, and, usually, longer shelf-life than the traditional dry cell or alkaline batteries.

The selection of a more active negative electrode has a number of design, materials, and operational consequences. In particular, water is no longer an acceptable solvent for the electrolyte. In fact, water must be specifically excluded from the electrolyte and kept from entering the battery from the outside environment. This requirement that lithium batteries be hermetically sealed initially led to the design of battery containers made of stainless steel with glass-to-metal seals surrounding the electrical feed-throughs and requiring a welding step to effect the final hermetic seal. These battery containers are very effective at preventing the entry of moisture from the environment, but also have several disadvantages.

Stainless steel battery containers are heavy and expensive. To reduce component costs, battery containers are typically cylindrical in shape. However, cylindrical batteries do not pack efficiently when several must be combined into a multi-cell battery. A further design and cost disadvantage associated with steel containers is the requirement for a designed weakening in the steel container to allow for a controlled rupture of the battery in the event of either internal or external heating of the battery. The controlled rupture is intended to deactivate the battery to prevent its explosion and the formation of hazardous shrapnel from the steel container.

Steel or other metal containers are required for those non-aqueous batteries which contain pressurized electrolytes, such as the lithium/sulfur dioxide battery. However, the development of lithium-based primary (non-rechargeable) and secondary (rechargeable) batteries using solid positive electrodes and organic solvent-based electrolytes, which have relatively low vapor pressures at operating temperatures, has led to the development of battery containers made of flexible, typically heat-sealable, polymeric films. Such batteries are commonly referred to as “pouch” cells or batteries.

Pouch cells offer significant advantages over cells contained in metal cans. They are less expensive and lighter, and significantly safer, as the flexible container does not allow internal pressures to build to a hazardous level and does not produce hazardous metallic fragments. The flexible containers associated with pouch cells comply with the shape of internal cell components, and they also expand, contract, bend and otherwise change shape in response to external pressure on the container surfaces. Pouch cells can also be fabricated in a wide variety of shapes to permit efficient packing of many cells into multi-celled batteries or to conform with the shape of the device being powered.

A pouch cell is typically produced by first assembling a sandwich comprising the negative electrode, the separator, and the positive electrode. This assembly may be in the form of alternating flat plates, spirally wound strips, or other configuration known in the art. For the pouch cell, it is common to form a flattened structure in which the electrodes and separator material are wound in the form of an elliptical spiral.

In separate operation, a pouch is formed, typically by a heat-sealing process, along three edges. The polymer film may comprise more than one layer of film to provide the necessary barriers against the ingress of moisture and air from the outside environment, while providing the necessary inertness to attack by the electrolyte solvents.

After the electrode/separator sandwich has been placed in the pouch, the open end of the pouch, the open end of the pouch is closed by the insertion of a cap unit or by heat sealing and/or adhesives. The final sealing design and process must make provisions for the passage of electrical connectors from the inside to the outside of the pouch and must also make provisions for the subsequent introduction to the electrolyte solution and the final sealing of that means of introduction.

U.S. Pat. No. 6,207,318 to Wessel et al. which is herein incorporated by reference, discloses a method for filing a battery pouch to ensure that the electrolyte is substantially restricted to the pores of the electrode and the separator.

U.S. Pat. No. 6,042,966 to Cheu, which is herein incorporated by reference, discloses a battery pouch which is resistant to shorting by folding the packaging laminate such that the cut edge of the laminate is physically removed and electrically protected from the electrode tab which protrudes from the pouch.

### SUMMARY OF THE INVENTION

The present invention provides a pouch or container for a battery system having an electrolyte which is heat sealed and does not permit permeation of the vapors of the electrolyte, or the solvents. The pouch comprises at least one layer of a polyolefin and at least one layer of a non-fluorinated polymer selected from the group consisting of polyethylene vinyl alcohol copolymer (EVOH), polyamide, polyaramide, and polyurethane. Preferably the polyolefin is a low density polyethylene.

According to another embodiment of the invention, there is provided an electrochemical cell comprising a pouch of the invention which contains on the inside at least one negative electrode, at least one positive electrode, a porous separator positioned between the positive and negative electrode, electrical contacts attached to the negative and positive electrode protruding from said pouch, and a hermetic seal on the pouch about the electrical contacts, said pouch containing an electrolyte.

The electrochemical cell can either be a primary or a secondary rechargeable battery.

According to a further embodiment of the invention there is provided a lining for a container holding an electrolyte.

It is a general object of the invention to provide a pouch for electrochemical cells which is electrolyte impervious and prevents vapor penetration of solvents out of the pouch and water vapor into the pouch.

It is a further object of the invention to provide electrochemical cells comprising the pouch of the invention.

Other objects and advantages of the invention will be seen from the drawing and a reading of the description of the preferred embodiments of the invention.

### BRIEF DESCRIPTION OF THE DRAWINGS

FIG. 1—is a cross-sectional view of a film of the invention.

FIG. 2—is a cross-sectional view of an electrochemical cell with the pouch formed by the film of FIG. 1.

FIG. 3—is a cross-sectional view of another electrochemical cell according to the invention.

### DESCRIPTION OF THE PREFERRED EMBODIMENTS

The non-aqueous electrochemical battery of the present invention comprises a negative electrode, a positive electrode, a porous separator positioned between the negative and positive electrodes, a non-aqueous electrolyte and a flexible container enclosing the electrodes, separator and electrolyte. The electrolyte resides substantially in the pores of the electrodes and the separator. The electrochemical battery may be designed for a single discharge (primary battery) or for multiple discharges and recharges (secondary battery).

In a first embodiment, the battery is non-rechargeable. In the preferred first embodiment, the negative electrode comprises a material which is selected from the group consisting of alkali metals, alkaline earth metals, alkali metal alloys, and alkaline earth metal alloys. Most preferably, the negative electrode comprises lithium. In the preferred first embodiment, the liquid solvent of the electrolyte is selected from the group consisting of LiClO₄, LiPF₆, LiBF₄, LiAsF₆, LiSO₂CF₃, LiN(CF₃SO₂)₂, and LiN(SO₂C₄F₉)(SO₂CF₃). Most preferably, the electrolyte comprises LiPF₆, ethylene carbonate, and dimethyl carbonate, or tetrahydrofuran, or butyrolactone or dimethoxyethane. In the preferred first embodiment, the positive electrode comprises a binder, a conductant, and a transition metal compound, which conductant is defined as a material added to enhance electrical conductivity. Most preferably, the positive electrode comprises manganese dioxide, carbon, lithium cobalt oxide, and a fluorocarbon binder coated on an expanded metal substrate.

In a second embodiment, the battery is rechargeable. In the preferred second embodiment, the negative electrode electroactive material is selected from the group consisting of lithiated carbon, lithiated nitrogen-doped carbon, boron-doped carbon, and lithiated metal sulfides. Most preferably, the negative electrode is lithiated graphite. In the preferred second embodiment, the liquid solvent of the electrolyte is selected from the group consisting of linear carbonate esters, cyclic carbonate esters, linear carboxylic esters, THF, methyl formate, ethyl propionate, ethylene glycol, dimethylethyl ether, cyclic carboxylic acid esters, linear esters, cyclic esthers, and mixtures thereof In the preferred second embodiment the conductive salt is about 8-20% by weight of the electrolyte and is selected from the group consisting of lithium triflate, LiClO₄, LiBF₄, LiAsF₆, LiSO₂CF₃, LiN(CF₃SO₂)₂, LiN(SO₂C₄F₉)(SO₂CF₃), and LiPF₆. Most preferably, the electrolyte comprises LiPF₆, ethylene carbonate, and one of dimethyl carbonate, ethyl methyl carbonate, diethyl carbonate, or a mixture of diethyl carbonate and dimethyl carbonate. In the preferred second embodiment, the positive electrode is polyvinylidene fluoride, carbon and a lithiated cobalt oxide on a conducting substrate.

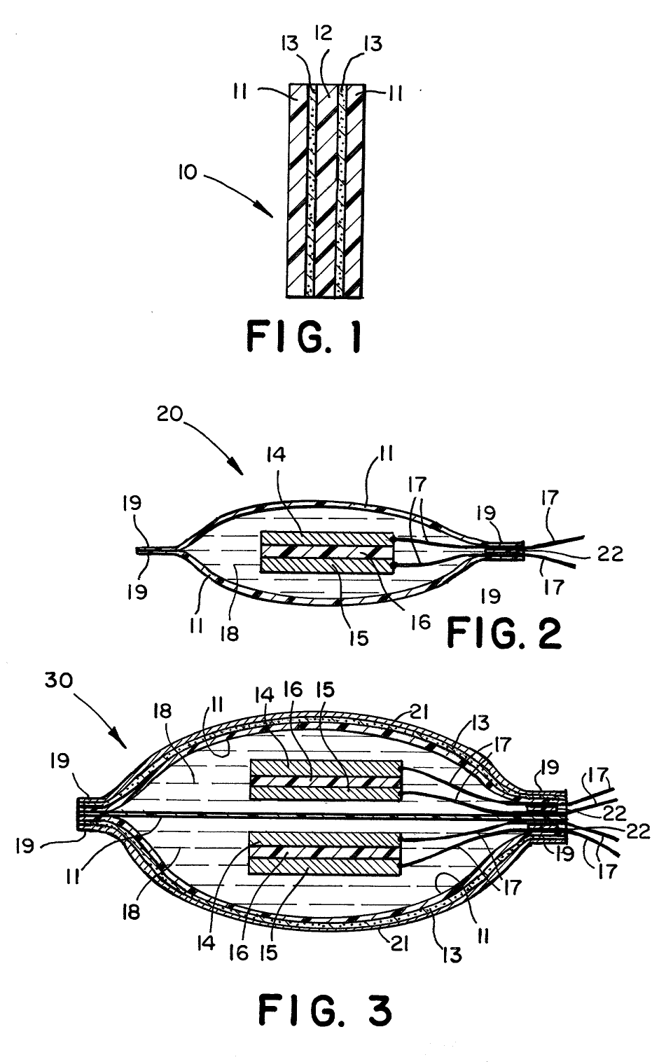

According to the present invention the film forming the pouch for the battery is multi-layered and has a thickness of at least 3 mils, preferably 3-14 mils, composed of at least two film layers that are adhesively bound, which consist of a polyolefin film such as polyethylene and one of a polar film such as polyethylene vinyl alcohol copolymer (EVOH), a polyamide, a polyaramide, a polyurethane, and the like. The preferred polyolefin is a low density polyethylene and the preferred polar polymer film comprises EVOH. Most preferable, the polar polymer film is adhesively sandwiched between two polyolefin films having one or more layers. A suitable film 10, according to the invention is illustrated in FIG. 1, wherein a film layer of EVOH 12, is sandwiched between at least two low density polyethylene films 11, by an adhesive 13.

As illustrated in FIG. 2, an electrochemical cell 20, is formed with the film of FIG. 1 forming a pouch. Within the pouch is a cathode 14, and an anode 15, with a separator 16. Each of anode 15 and cathode 14, have an electrode tab 17, projecting form the pouch. The film 10, is formed into a pouch by folding over the edges and heat sealing the polyethylene edges together. Alternatively, a sealing strip 19, such as a copolymer layer consisting of a polyolefin containing acrylic or methacrylic acid or a polyolefin containing at least 15% by weight acrylate or methacrylate ester, preferably polyethylenelmethacrylic acid (NUCREL™ of Dupont Co.) can be utilized. The pouch can contain or later be filled with a suitable electrolyte 18.

As shown in FIG. 3 a battery 21, can be prepared containing a multiplicity of cells such as illustrated in FIG. 2. In addition, the battery may comprise as outer-aluminized film layer 22.

The aluminum layer is generally a small-grained aluminum foil which is generally flexible and/or moldable by pressure molding.

The separators used in the invention are well known in the art. Preferred are the porous polypropylene materials or porous KYNAR™ films.

The low-density polyethylene is relatively easy to heat seal to itself in a fusion bond which is strong and resistant to attack by the aggressive solvents contained in the flexible battery cell. In addition, there is a synergistic effect in which the polar film layer in the middle of the multi-layer film is protected from attack by the solvents and from water absorption from outside of the cell. This enables the polar layer to perform at its optimum solvent vapor barrier resistance. The overall multi-layer film with the polar film inner layer outperforms any other construction or single film including fluoropolymers and aluminized bags.

The use of a lower melting polyethylene as the outer and inner surface of the multi-layer barrier film enables easy sealing to form a very strong fusion bond (only fails cohesively). Aluminum electrodes can also be sealed through the seams of the bag cell. The aluminum strip is best primed with a polyurethane layer, silane coupling agent or a polyacrylic acid layer. It is also advantageous to use a copolymer of ethylene and acrylic acid or methacrylic acid or their esters particularly copolymers of methyl acrylate and ethylene at the seal point between the barrier film and the aluminum or electrode material to ensure a strong liquid tight seal.

In some instances the entire battery consisting of one or more cells may be encased in such a flexible bag. It is optional to encase the bagged cell already described with an aluminized layer. Note that the aluminized plastic films, although improving the solvent barrier properties are still relatively porous since the aluminum film actually contains numerous holes and cracks and if thin enough is porous so that the vapors still diffuse through.

According to a further embodiment of the invention, the films of the present invention can be used as a liner in other pouches, housing for electrochemical cells and any container which holds an electrolyte.

The purchase, initial cleaning, and inerting of drums or other containers for shipping high purity electrolyte is expensive and time consuming. Usually such a flexible plastic or rubber container used for shipment is permeable to the organic carbonate solvents or acetonitrile. In addition these films are usually not totally resistant to the slow absorption or permeation of water through heat sealed bags composed of these films.

It has now been found that a 4-14 mil heat sealed bag made from a laminated layered film such as described in FIG. 1 using the EVOH middle layer is entirely effective in preventing the loss of volatile organic carbonate solvent from the electrolyte. This film is minimally an EVOH encased in two layers of HDPE. The bag is formed and then inserted into a drum or other container. The bag is filled several times with dry nitrogen to expand it and to flush it out. The electrolyte is then added through an inlet tube into the liner bag inside the container. After filling the narrow section of the bag constituting the filling port is heat-sealed.

### EXAMPLE 1

A film comprised of a sandwich of 2 mils of EVOH (polyethylene/vinyl alcohol copolymer) in between two 1.5 mil layers of low density polyethylene with thin tie of bonding layers between each of the layers (overall thickness, 5.5 mils) was made into a pouch (bag) (3″×4″) by thermally heat sealing two pieces of the film together only on three edges.

Two primed aluminum strips (foil) were laid perpendicular to the open edge of the pouch running from inside the bag to the outside across the seam to be closed. A small strip of 10 mils polyethylene/methacrylic acid (Nucrel 960) was laid on either side of the aluminum strip and in the area of the bag where the seam was to be closed. The total configuration was then heat sealed across the final seam. A corner of the bag was cut off so that the bag could be filled with electrolyte. The small open corner was heat sealed thus forming a sealed prototype cell. The filled cell was encapsulated in a foil bag at room temperature for several days. The foil bag was carefully opened after a month and the argon filled space surrounding the bag was checked by smell and gas chromatography as to whether solvent permeation occurred. No detectable solvent was found.

### EXAMPLE 2

A film comprised of a sandwich of 2 mils of EVOH (polyethylene/vinyl alcohol) in between two 1.5 mil layers of low density polyethylene with thin tie or bonding layers between each of the layers (overall thickness, 5.5 mils) was made into a pouch (bag) (3″×4″) by thermally heat sealing two pieces of the film together only to three edges.

Two primed aluminum strips (foil) were laid perpendicular to the open edge of the pouch running from inside the bag to the outside across the seam to be closed. A small strip of about 10 mil polyethylene/methyl acrylate (Exxon Copolymer 221) was laid on either side of the aluminum strip and in the area of the bag where the seam was to be closed. The total configuration was then heat sealed across the final seam. A corner of the bag was cut off so that bag could be filled with electrolyte. The small open corner was heat sealed thus forming a seal prototype cell. The filled cell was encapsulated in a foil bag at room temperature for several days. The filled bag was carefully opened after a month and the argon filled space surrounding the bottle checked by smell and gas chromatography as to whether solvent permeation occurred. No detectable solvent was found.

These solvent vapor impermeable films can also be used for forming a protective barrier (bag) for the inside of containers and drums containing organic battery or capacitor electrolyte solutions when totally sealed. In this manner, less expensive containers or drums (disposable) can be used for shipping these organic electrolyte solutions.

While the preferred embodiments of the invention have been illustrated and described, it will be clear that the invention is not so limited. Numerous modifications, changes, variations and equivalents will occur to those skilled in the art without departing from the scope and spirit of the claimed invention

What is claimed is:

1. A method for preparing a pouch containing an electrochemical cell, said method comprising:
a. providing a battery cell having at least one electrode tab protruding therefrom;
b. forming a pouch to enclose said battery and said at least one electrode, said pouch comprising a multi-layered film having a thickness of about 3 to 14 mils of at least one layer of a polar polymer selected from the group consisting of polyethylene vinyl alcohol copolymer, polyamide, polyaramide and polyurethane sandwiched between two polyolefin films and adhering thereto by a tie layer0;
c. providing an electrolyte, and;
d. sealing said pouch

2. The method of claim 1 wherein said pouch comprises polyethylene vinyl alcohol copolymer sandwiched between at least one layer of low density polyethylene.

3. The method of claim 1 which includes partially encapsulating said electrode tab by a copolymer layer consisting of copolymer of ethylene and a member selected from the group consisting of acrylic acid, methacrylic acid, methacrylate ester and acrylate ester.

4. The method of claim 1 including providing a sealing strip of a copolymer layer of a polyolefin and an acrylic or methacrylic acid or ester.

5. A battery package, said package comprising:
a. a battery having at least one electrode tab protruding therefrom; and
b. a pouch which encloses said battery and which partially encloses said electrode tab, said pouch comprising a multi-layered film having a thickness of about 3 to 14 mils of at least one layer of a polar film selected from the group consisting of polyethylene vinyl alcohol copolymer, polyamide, polyaramide and polyurethane sandwiched between two polyolefin films and adhering thereto by a tie layer.

6. The battery package of claim 5 including an outer layer of aluminum

7. The battery package of claim 5 wherein said pouch comprises a film layer of polyethylene vinyl alcohol copolymer sandwiched between at least one layer of low density polyethylene.

8. The battery package of claim 5 wherein said battery is rechargeable.

9. A non-aqueous electrochemical cell comprising:
a negative electrode;
a positive electrode;
a porous separator positioned between said negative electrode and said positive electrode;
an electrolyte solution comprising a liquid electrolyte and a conductive salt; and
a flexible, fluid impermeable container containing said negative electrode, said positive electrode, said separator, and said electrolyte solution, wherein said container comprises a layer of a polar film selected from the group consisting of polyethylene vinyl alcohol copolymer, polyamide, polyaramide and polyurethane sandwiched between two polyolefin films and adhering thereto by a tie layer.

10. The electrochemical cell of claim 9 including an aluminum outer layer attached to said container.

11. The electrochemical cell of claim 10 wherein said container comprises a film layer of polyethylene vinyl alcohol copolymer sandwiched between at least one layer of low density polyethylene.

12. In a container for holding an electrolyte, the improvement which comprises including a liner formed by a multi-layered film having a thickness of about 3 to 14 mils of at least one layer of a polar polymer selected from the group consisting of polyethylene vinyl alcohol copolymer, polyamide, polyaramide, and polyurethane sandwiched between two polyolefin films and adhering thereto by a tie layer.
